(19) United States
(12) Patent Application Publication
(10) Pub. No.: US 2006/0165895 A1
(43) Pub. Date: Jul. 27, 2006

(54) System and a method for synthesizing nanoparticle arrays in-situ

(76) Inventor: Julio Cartagena, Isabela, PR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/042,640

(22) Filed: Jan. 24, 2005

(51) Int. Cl. B05D 5/12; B05D 1/36; B05D 7/00; B05B 13/02; B05C 5/00; B05C 11/00

(52) U.S. Cl. 427/258; 427/402; 427/58; 118/300; 118/305; 118/679

(57) ABSTRACT

A method for forming nanoparticles in-situ includes depositing a first nanoparticle reactant from a printhead onto a desired substrate, and depositing a second nanoparticle reactant from the printhead substantially onto the first reactant, wherein the first nanoparticle reactant is configured to react with the second nanoparticle reactant to form a nanoparticle.

### BACKGROUND

Inkjet printing has been used to deposit nanoparticles on substrates. These traditional methods include firing a prepared nanoparticle suspension onto a desired substrate. However, these traditional methods lacked the ability to be workable with precise material dispensing inkjet systems. More specifically, the traditional nanoparticle suspensions often include strong organic solvents and dispersion-stabilizing agents to avoid precipitation. These strong organic solvents and dispersion-stabilizing agents are not compatible with inkjet materials.

Additionally, traditional methods of depositing nanoparticles onto a desired substrate included depositing reactive components that produced toxins and other undesirable byproducts of highly exothermic reactions.

### SUMMARY

A method for forming nanoparticles in-situ includes depositing a first nanoparticle reactant from a printhead onto a desired substrate, and depositing a second nanoparticle reactant from the printhead substantially onto the first reactant, wherein the first nanoparticle reactant is configured to react with the second nanoparticle reactant to form a nanoparticle.

### BRIEF DESCRIPTION OF THE DRAWINGS

The accompanying drawings illustrate various embodiments of the present system and method and are a part of the specification. The illustrated embodiments are merely examples of the present system and method and do not limit the scope thereof.

FIG. 1 is a simple block diagram illustrating an apparatus for synthesizing nanoparticles in-situ, according to one exemplary embodiment.

FIG. 2 is a perspective view of an inkjet printhead, according to one exemplary embodiment.

FIG. 3 is a top view of an inkjet printhead, according to one exemplary embodiment.

FIG. 4 is a flowchart illustrating a method for forming nanoparticle arrays in-situ, according to one exemplary embodiment.

FIGS. 5A to 5E are side views illustrating the nanoparticle array formation method of FIG. 4, according to one exemplary embodiment.

FIG. 5F is a top view illustrating a nanoparticle array formed by the nanoparticle array formation method of FIG. 4, according to one exemplary embodiment.

FIG. 6 is a perspective view illustrating a biological sensor model formed by the present nanoparticle array formation, according to one exemplary embodiment.

FIG. 7 is a top view illustrating nanoparticle sensors that may be used in the exemplary biological sensor illustrated in FIG. 6, according to one exemplary embodiment.

Throughout the drawings, identical reference numbers designate similar, but not necessarily identical, elements.

### DETAILED DESCRIPTION

An exemplary system and method for synthesizing nanoparticle arrays in-situ is disclosed herein. More specifically, a system and a method are disclosed that may be used in the creation of nanoparticle arrays, electrical traces, and/or small electrical components. According to one exemplary embodiment, the desired nanoparticle arrays, electrical traces, and/or small electrical components are formed by first selectively ejecting a first reactant on a desired substrate and then depositing a second reactant substantially on top of the previously deposited first reactant, both reactants being deposited from a single printhead. According to the present exemplary embodiment, the single inkjet printhead that is used to deposit the various reactants includes multiple chambers that chemically separate the reactants prior to deposition. As used in the present specification, and in the appended claims, a second reactant may be considered to be substantially deposited on a first deposited reactant if the first and second reactants are overlapping in any way.

In the following description, for purposes of explanation, numerous specific details are set forth in order to provide a thorough understanding of the present system and method for synthesizing nanoparticle arrays in-situ. It will be apparent, however, to one skilled in the art, that the present method may be practiced without these specific details. Reference in the specification to “one embodiment” or “an embodiment” means that a particular feature, structure, or characteristic described in connection with the embodiment is included in at least one embodiment. The appearance of the phrase “in one embodiment” in various places in the specification are not necessarily all referring to the same embodiment.

Exemplary Structure

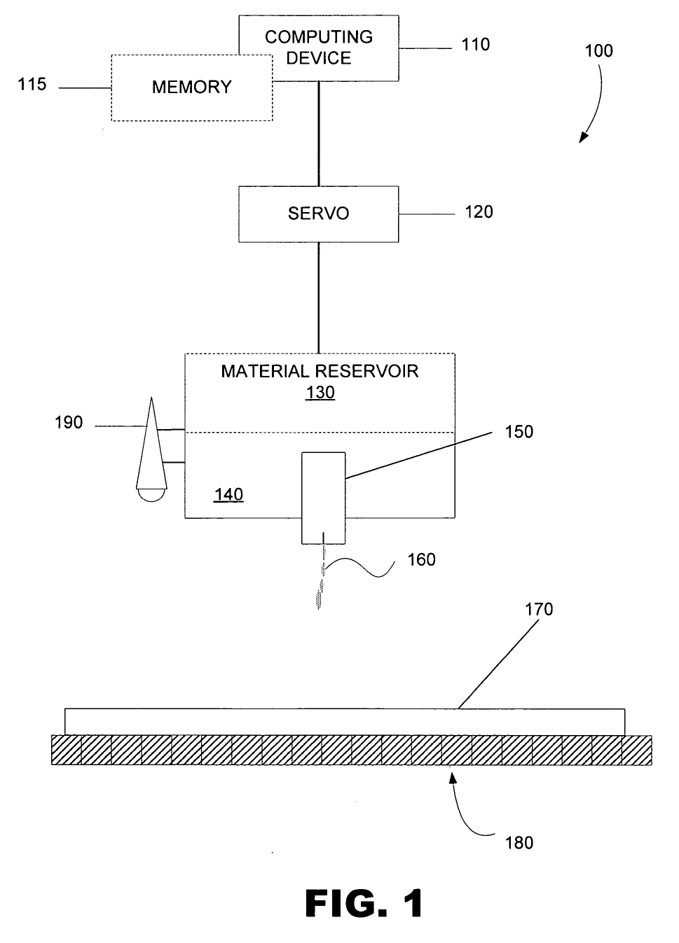

FIG. 1 illustrates an exemplary system (100) that may be used to form a number of nanoparticle arrays and/or electrical traces on a desired substrate (180), according to one exemplary embodiment. As illustrated in FIG. 1, nanoparticle forming reactants (160) may be independently applied to a desired substrate (170) from a single inkjet material dispenser (150). As shown in FIG. 1, the present system includes a computing device (110) controllably coupled through a servo mechanism (120) to a moveable carriage (140) having the inkjet material dispenser (150) disposed thereon. A material reservoir (130) is also coupled to the moveable carriage (140), and consequently to the inkjet print head (150). A transporting medium (180) having the desired substrate (170) disposed thereon is located adjacent to the inkjet material dispenser (150). While the present embodiment is described, for ease of explanation only, in the context of forming a nanoparticle array in-situ on the desired substrate (170), the present system and method may be used to form any number of very small electrical, chemical, and/or biological components on any number of receiving substrates including, but in no way limited to, printed circuit boards, switches, ingestible sheets etc. The above-mentioned components of the present system will now be described in further detail below.

The computing device (110) that is controllably coupled to the servo mechanism (120), as shown in FIG. 1, controls the selective deposition of nanoparticle forming reactants (160). A representation of a desired array structure or trace pattern may be formed using a program hosted by the computing device (110). That representation of the desired array structure or pattern may then be converted into servo instructions that are housed in a processor readable medium or memory (115). When accessed by the computing device (110), the instructions housed in the processor readable medium (115) may be used to control the servo mechanisms (120) as well as the movable carriage (140) and inkjet material dispenser (150). The computing device (110) illustrated in FIG. 1 may be, but is in no way limited to, a workstation, a personal computer, a laptop, a personal digital assistant (PDA), or any other processor containing device.

The moveable carriage (140) of the present reactant dispensing system (100) illustrated in FIG. 1 is a moveable material dispenser that may include any number of inkjet material dispensers (150) configured to dispense the present nanoparticle forming reactants (160). The moveable carriage (140) may be controlled by the computing device (110) and may be controllably moved by, for example, a shaft system, a belt system, a chain system, etc. making up the servo mechanism (120). As the moveable carriage (140) operates, the computing device (110) may inform a user of operating conditions as well as provide the user with a user interface. Alternatively, the desired substrate (170) may be selectively translated under a stationary inkjet material dispenser (150) by a servo mechanism.

As a desired pattern or array structure of nanoparticle forming reactants is printed on a desired substrate (170), the computing device (110) may controllably position the moveable carriage (140) and direct one or more of the inkjet material dispensers (150) to selectively dispense the nanoparticle forming reactants (160) at predetermined locations on the desired substrate (170) as digitally addressed drops, thereby forming layers of the desired nanoparticle arrays or electrical traces. The inkjet material dispensers (150) used by the present printing system (100) may be any type of inkjet dispenser configured to perform the present method including, but in no way limited to, thermally actuated inkjet dispensers, mechanically actuated inkjet dispensers, electrostatically actuated inkjet dispensers, magnetically actuated dispensers, piezoelectrically actuated dispensers, continuous inkjet dispensers, etc. Moreover, the present nanoparticle forming reactants can alternatively be distributed using any number of printing processes including, but in no way limited to, inkjet printing, lithography, screen printing, gravure, flexo printing, and the like.

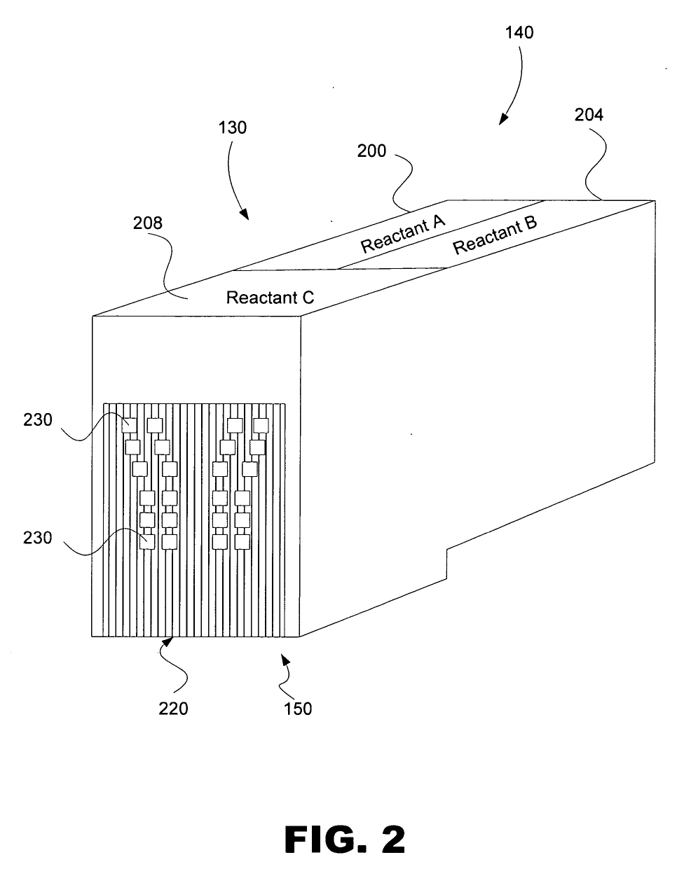

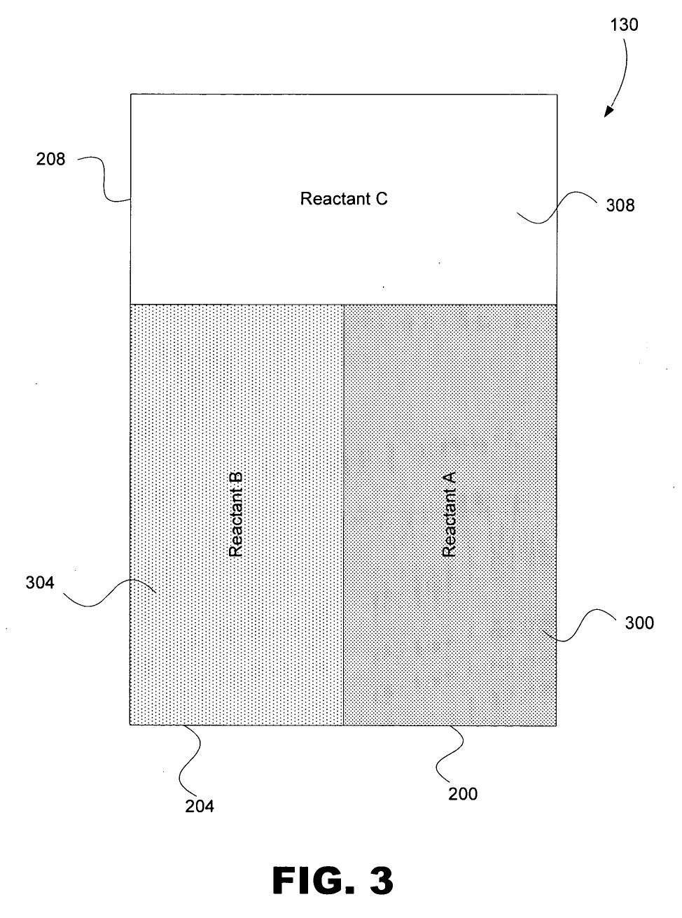

The material reservoir (130) that is fluidly coupled to the inkjet material dispenser (150) houses the present nanoparticle forming reactants (160) prior to printing. The material reservoir may be any container configured to hermetically seal the present nanoparticle forming reactants (160) prior to printing and may be constructed of any number of materials including, but in no way limited to metals, plastics, composites, or ceramics. Moreover, the material reservoir (130) may be an off-axis or on-axis component. According to one exemplary embodiment illustrated in FIG. 1, the material reservoir (130) forms an integral part of the moveable carriage (140). Further details of the present material reservoir (130), the inkjet material dispensers (150), and the nanoparticle forming reactants (160) contained in the material reservoir (130) will be given below with reference to FIGS. 2 and 3.

According to one exemplary embodiment illustrated in FIG. 2, the material reservoir (130) and the inkjet material dispenser (150) forms an integral part of the moveable carriage (140). As illustrated, the material reservoir (130) includes a plurality of chambers (200, 204, 208) housing and chemically separating a plurality of nanoparticle forming reactants. According to this exemplary embodiment, the various nanoparticle forming reactants are chemically isolated from one another, thereby preventing their spontaneous combination and reaction. As illustrated, the various nanoparticle forming reactants may be stored in their respective chambers (200, 204, 208) until dispensed by the inkjet material dispenser (150). As shown in FIG. 2, the inkjet material dispenser (150) includes a number of electrical contacts (230) that may be used to selectively eject one or more of the multiple nanoparticle forming reactants from the inkjet material dispenser (150). While a thermal inkjet material dispenser having a number of orifices (220) configured to eject one or more nanoparticle forming reactants is illustrated in FIG. 2, any number of inkjet material dispensers (150) described above may be incorporated by the present system and method.

FIG. 3 is a top view further illustrating the separation of the multiple nanoparticle forming reactants (300, 304, 308) housed in the material reservoir (130), according to one exemplary embodiment. As illustrated in FIG. 3, a first reactant (300) ‘reactant A’ may be contained in a first material chamber (200), a second reactant (304) ‘reactant B’ may be housed in a second material chamber (204), and a third reactant (308) ‘reactant C’ may be contained in a third material chamber (308). According to the present exemplary embodiment, the first, second, and third reactants (300, 304, and 308 respectively) may be any number of reactants that, when combined, form a desired nanoparticle array and/or electrical trace. According to one exemplary embodiment, one or more of the reactants (300, 304, and 308) may include, but is in no way limited to, a gold (Au) precursor, a silver (Ag) precursor, and/or a reducing agent. More specifically, according to the present exemplary embodiment, one or more of the reactants (300, 304, and 308) may include, but are in no way limited to, a gold (Au) precursor such as, for example, gold chloride (AuCl₄) dissolved in water for jettability; a silver (Ag) precursor such as, for example, silver nitrate (AgNO₃) dissolved in water for jettability; and/or a reducing agent such as, for example, sodium citrate (Na₃C₆H₅O₇), potassium hydroxide (KOH), or potassium sulfite (K₂SO₃) dissolved in water for jettability.

According to the present exemplary embodiment, the present inkjet material dispenser (150) may selectively eject droplets from one or more of the illustrated material chambers (200, 204, 208) to form a desired nanoparticle array or electrical trace, as will be further described in detail below. While the present exemplary material reservoir (130) is illustrated in the context of three separate material chambers (200, 204, 208), any plurality of material chambers and/or material reservoirs (130) may be incorporated by the present system and method.

Returning again to FIG. 1, a radiation applicator (190) is shown coupled to the carriage (140). The radiation applicator (190) shown in FIG. 1 is configured to apply radiation to dispensed nanoparticle forming reactants (160) after deposition. Once deposited, the radiation applicator (190) may apply any number of curing lights including, but in no way limited to ultraviolet (UV) radiation, infrared (IR) radiation, lasers, and/or microwaves. As shown in FIG. 1, the radiation applicator (190) may be coupled to the carriage (140) as a scanning unit. Alternatively, the radiation applicator (190) may be a separate light exposer or scanning unit configured to flood expose all or selective portions of deposited nanoparticle forming reactants (160).

As illustrated in FIG. 1, the desired substrate (170) illustrated in FIG. 1 may be any number of nanoparticle or trace receiving substrates, according to the present system and method. More specifically, according to one exemplary embodiment, the desired substrate may be a glass slide or substrate configured to receive a plurality of nanoparticle forming reactants (160) that form a nanoparticle array. Alternatively, the desired substrate (170) may include a printed circuit board configured to receive a plurality of nanoparticle forming reactants (160) that react to form an electrical trace, connection, and/or component.

FIG. 1 also illustrates the components of the present system that facilitate reception of the nanoparticle forming reactants (160) on the desired substrate (170). As shown in FIG. 1, a belt or other transporting medium (180) may transport and/or positionally secure a desired substrate (170) during a reactant dispensing operation. The exemplary method for forming the desired nanoparticle arrays and/or electrical traces with the above-described system (100) will now be described in further detail below.

Exemplary Forming Methods

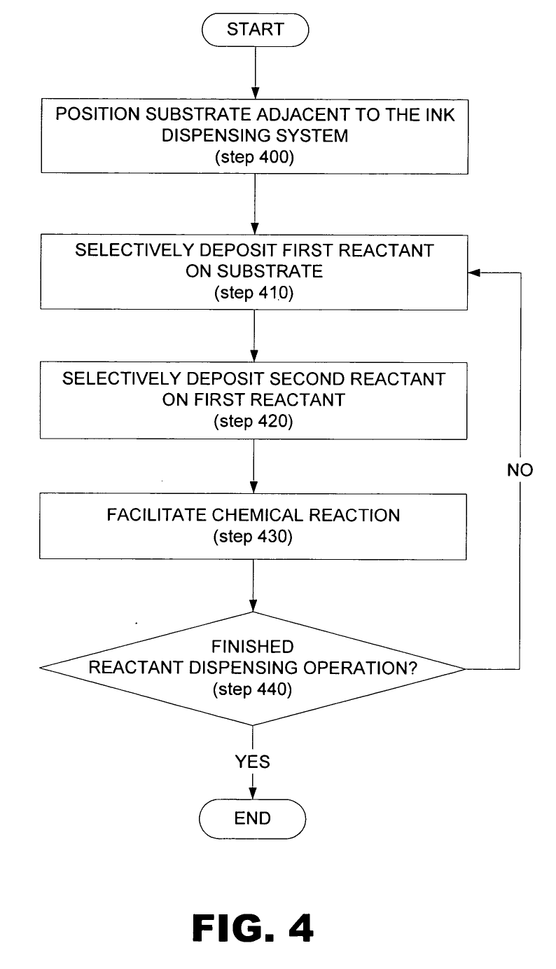

FIG. 4 illustrates an exemplary method for forming a number of nanoparticle arrays and/or electrical traces on a desired substrate (180), according to one exemplary embodiment. As illustrated in FIG. 4, the present exemplary method begins by first positioning the desired substrate adjacent to the inkjet material dispensing system (step 400). Once correctly positioned, the inkjet material dispenser may selectively deposit a first reactant onto the desired substrate (step 410). Once the first reactant is deposited on the desired substrate, a second reactant may then be selectively deposited substantially on the first deposited reactant (step 420) by the same inkjet material dispenser. According to the present exemplary embodiment, a second reactant may be considered to be substantially deposited on a first deposited reactant if the first and second reactants are completely overlapping, partially overlapping in any way, or if one reactant deposition is contained within another. After both the first and the second reactants have been deposited and combined on the desired substrate, their reaction may be facilitated (step 430). The present system then determines if the desired reactant dispensing operation has been completed (step 440). If the desired reactant dispensing operation has not yet been fully completed (NO, step 440), the present method again selectively deposits a first reactant on a desired substrate (step 410) and the process repeats itself. If, however, the system determines that the desired reactant dispensing operation is complete (YES, step 440), the operation ends. The above-mentioned steps will now be described in further detail below.

As shown in FIG. 4, the present exemplary method for forming a number of nanoparticle arrays and/or electrical traces on a desired substrate (170) begins by first positioning a desired substrate adjacent to an inkjet material dispensing system (step 400). As shown in FIG. 1, the desired substrate material (170) may be positioned under the inkjet material dispensing system (100) by a belt, rollers, or other transporting medium (180). Alternatively, an operator may manually place the desired substrate material (170) adjacent to the inkjet material dispensing system (100).

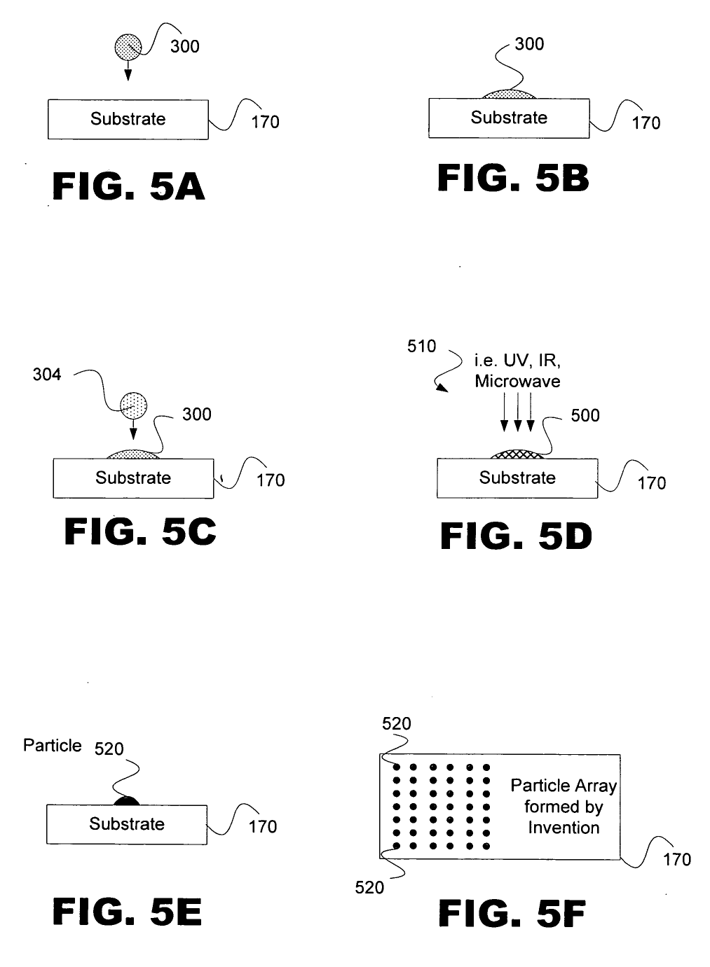

Once the desired substrate material (170) is correctly positioned, the inkjet material dispensing system (100) may be directed by the computing device (1 10) to selectively deposit a first nanoparticle forming reactant (160) onto the desired substrate (step 410; FIG. 4). As was mentioned previously, the array or pattern to be printed on the desired substrate (170) may initially be developed on a program hosted by the computing device (110). The created image may then be converted into a number of processor accessible commands, or a print script, which when accessed, may control the servo mechanisms (120) and the movable carriage (140) causing them to selectively emit nanoparticle forming reactants (160) onto the desired substrate. According to one exemplary embodiment illustrated in FIGS. 5A through 5F, a first reactant (300) may be emitted from the inkjet material dispenser (150; FIG. 1) and be deposited on the desired substrate (170). The nanoparticle forming reactants (160) may be emitted by the inkjet material dispensing system (100) to form any number of arrays or traces including, but in no way limited to, electrical traces, micro-electrical components, and/or nanoparticle arrays. Precision and resolution of the resulting arrays or traces may be varied by adjusting a number of factors including, but in no way limited to, the type of inkjet material dispenser (150) used, the distance between the inkjet material dispenser (150) and the desired substrate (170), and the reactant dispensing rate.

According to one exemplary embodiment, the processor accessible commands used to control the servo mechanisms (120) and the movable carriage (140) are configured to cause the inkjet material dispensing system (100) to selectively deposit a first reactant on the desired substrate in the desired pattern or array (step 410; FIG. 4), followed by selectively depositing a second reactant (304) in substantially the same desired pattern or array (step 410; FIG. 4). As illustrated in FIG. 5C, the second reactant (304) is deposited directly on top of the first deposited reactant (300) where they may combine and react to form the desired nanoparticles. By independently depositing the first and second nanoparticle forming reactants on the desired substrate (170) in the small quantities possible with inkjet material dispensers, the violent exothermic reactions that often accompany nanoparticle forming reactions are controlled. Additionally, since the multiple reactants are combined on the desired substrate to form the nanoparticles, rather than ejecting the nanoparticles from the inkjet material dispensers, highly concentrated mixtures can be used, thereby enabling faster array formation. Moreover, the resulting array formation or electrical trace is very precise (1 drop=1 array spot), eliminating the need for array purification. Further, because the reactants are independently stored as solutions in the separate material chambers (200, 204, 208; FIG. 2) of the material reservoir (130) and not combined until deposited on the desired substrate (170), there are no reactant storage issues in regards to liquid stability, precipitation, etc.

Returning again to FIG. 4, once the first (300; FIG. 5C) and second (304; FIG. 5C) nanoparticle forming reactants have been deposited and combined on the desired substrate (170) to form a reactive mixture (500; FIG. 5D), the chemical reaction may be facilitated (step 430). According to one exemplary embodiment illustrated in FIG. 5D, the chemical reaction of the reactive mixture (500) may be facilitated by emitting ultraviolet (UV), infrared (IR), and/or microwaves (510) onto the reactive mixture (500). Alternatively, according to one exemplary embodiment, the chemical reaction of the reactive mixture (500) may be facilitated by inducing localized heating through the application of any number of heat sources including, but in no way limited to, a laser, microwaves, UV rays, IR rays, and/or resistive heating of the desired substrate (170).

As illustrated in FIG. 5E, the application of the localized heating facilitates the chemical reaction in the reactive mixture (500) to reduce the metallic precursor and form a desired nanoparticle (520) on the desired substrate (170). Moreover, as illustrated in FIG. 5F, the above-mentioned method may be used to form multiple nanoparticles (520) in an array formation on the desired substrate (170).

Returning again to FIG. 4, once the chemical reaction has been facilitated by localized heating (step 430), the present system will determine if the reactant dispensing operation is complete (step 440). According to one exemplary embodiment, the exemplary system (100; FIG. 1) determines if all of the desired reactants have been deposited on the desired substrate, according to the processor accessible commands, or print script, which when accessed, cause the servo mechanisms (120; FIG. 1) and the movable carriage (140; FIG. 1) to selectively emit nanoparticle forming reactants (160; FIG. 1) onto the desired substrate. If not all of the desired nanoparticle forming reactants (160; FIG. 1) have been deposited on the desired substrate (NO, step 440), the present exemplary method will again execute commands that cause the present system to selectively deposit a nanoparticle forming reactant onto the desired substrate (step 410) and the above-mentioned process continues. If, however, the exemplary system (100; FIG. 1) determines that all the desired nanoparticle forming reactants (160; FIG. 1) have been correctly deposited (YES, step 440), the nanoparticle formation method is complete.

While the above-mentioned system and method were described in the context of forming a desired nanoparticle by combining a first and a second nanoparticle forming reactant, any two or more particle forming reactants may be combined, according to the present exemplary embodiment. Additionally, while the above-mentioned exemplary method was described in the context of forming a nanoparticle array, the above-mentioned method may be incorporated to form any number of electrical components, traces, and/or structures on a desired substrate.

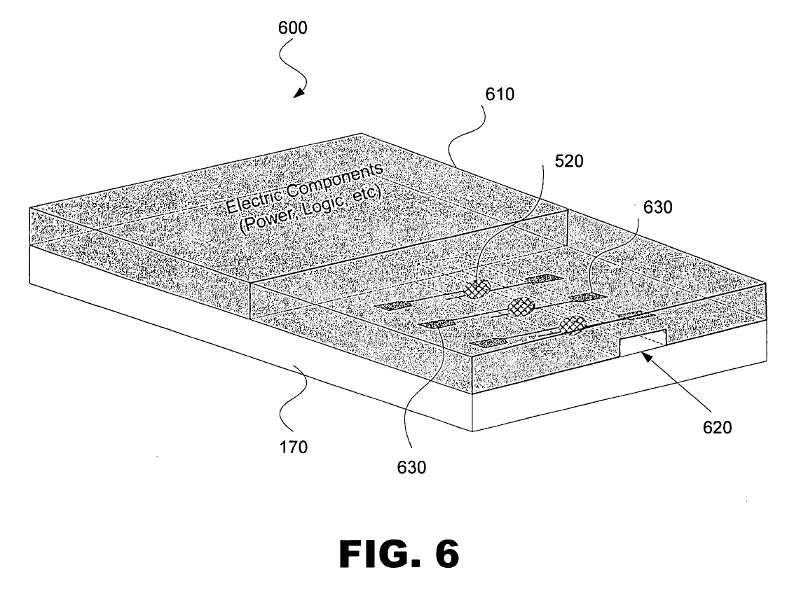

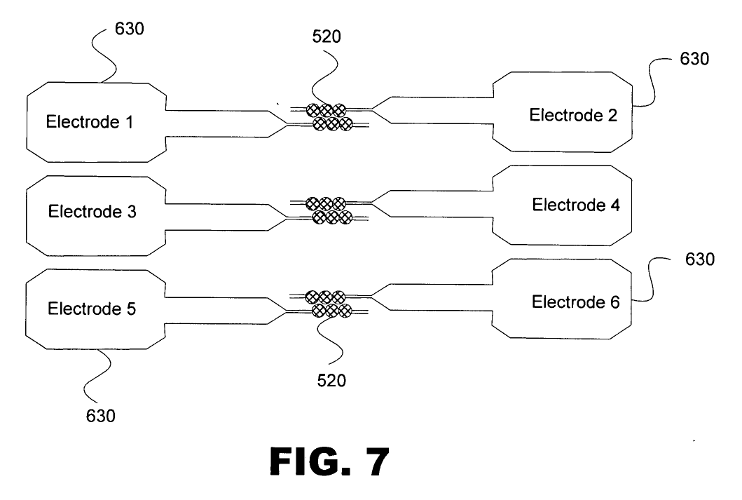

FIGS. 6 and 7 illustrate an exemplary application of the above-mentioned method for forming nanoparticle arrays in-situ. As illustrated in FIG. 6, a biosensor (600) may be formed by the above-mentioned system and method. In the exemplary embodiment shown in FIG. 6, a pre-fabricated thin film circuit containing inter-digitated conductive wires becomes the desired substrate (170). As illustrated, a number of electrodes (630) are formed on the desired substrate (170) and have conductive wires or electrodes extending there between. Additionally, a number of electronic components (610), such as power circuits, logic circuits, etc., are formed on the desired substrate (170). According to one exemplary embodiment, the above-mentioned deposition method is used to form an array of nanoparticles (520) in the spaces between the conductive wires (electrodes).

As illustrated in FIG. 7, the nanoparticles (520) provide electrical connection between pairs of electrodes (630). More specifically, according to one exemplary embodiment, the nanoparticles (520) are of a particular composition so as to react with a molecule to be detected. According to this exemplary embodiment, when the nanoparticles are placed in contact with a desired molecule, a complex is formed that changes the electrical mobility of electrons (current) through the pair of electrodes. This change in electrical mobility can then be detected by the electric components (610) functioning as a standard ampmeter.

Returning again to FIG. 6, the exemplary sensor (600) includes a micro-fluidic channel (620) formed therein that provides fluidic communication between the formed nanoparticles (520) and the external environment. According to one exemplary embodiment, the micro-fluidic channel (620) is formed in the exemplary sensor (600) after the above-mentioned formation of the nanoparticles (520) on the desired substrate (170). This two-step formation process allows for the use of any number of reactant deposition methods, as mentioned above. Alternatively, an access channel (not shown) or some other means for providing deposition access to the electrodes (630) may be used to form the desired nanoparticles (520) on the electrodes. According to this exemplary embodiment, a fluid that is to be tested for a desired molecule by the exemplary sensor (600) may then be presented to the micro-fluidic channel where it will contact the nanoparticles (520). The nanoparticles will then sense the presence of a desired molecule by changing their electrical conductivity in proportion to the amount of desired molecules in the fluid.

In conclusion, the present system and method for synthesizing nanoparticle arrays in-situ control the violent exothermic reactions that often accompany nanoparticle forming reactions. Additionally, since the reactants are combined on the desired substrate to form the nanoparticles, rather than ejecting the nanoparticles from the inkjet material dispensers, highly concentrated mixtures can be used, thereby enabling faster array formation. Moreover, the resulting array formation or electrical trace is very precise (1 drop=1 array spot), eliminating the need for array purification. Further, because the reactants are independently stored as solutions in the separate material chambers of the material reservoir, there are no issues in regards to liquid stability, precipitation, etc.

The preceding description has been presented only to illustrate and describe exemplary embodiments of the present system and method. It is not intended to be exhaustive or to limit the system and method to any precise form disclosed. Many modifications and variations are possible in light of the above teaching. It is intended that the scope of the system and method be defined by the following claims.

What is claimed is:

1. A method for forming nanoparticles in-situ comprising:
depositing a first nanoparticle reactant from a printhead onto a desired substrate; and
depositing a second nanoparticle reactant from said printhead substantially onto said first reactant;
wherein said first nanoparticle reactant is configured to react with said second nanoparticle reactant to form a nanoparticle.

2. The method of claim 1, further comprising facilitating a chemical reaction between said first nanoparticle reactant and said second nanoparticle reactant.

3. The method of claim 2, wherein said facilitating a chemical reaction comprises heating said desired substrate or applying one of an ultraviolet radiation, an infrared radiation, microwaves, or a laser to said first nanoparticle reactant and said second nanoparticle reactant.

4. The method of claim 1, wherein said printhead comprises one of a thermally actuated inkjet dispenser, a mechanically actuated inkjet dispenser, an electrostatically actuated inkjet dispenser, a magnetically actuated dispenser, a piezoelectrically actuated dispenser, or a continuous inkjet dispenser.

5. The method of claim 4, wherein said printhead further comprises a plurality of chemically separated chambers;
said chambers being configured to chemically separate said first nanoparticle reactant and said second nanoparticle reactant.

6. The method of claim 1, further comprising depositing said first and second nanoparticle reactants in a pattern on said desired substrate.

7. The method of claim 6, wherein said pattern comprises an array.

8. The method of claim 6, wherein said pattern comprises an electrical trace.

9. The method of claim 6, wherein said pattern comprises an electrical component.

10. The method of claim 1, wherein said first nanoparticle reactant comprises one of a gold (Au) precursor or a silver (Ag) precursor.

11. The method of claim 10, wherein said gold precursor comprises gold chloride (AuCl₄) dissolved in water.

12. The method of claim 10, wherein said silver precursor comprises silver nitrate (AgNO₃) dissolved in water.

13. The method of claim 1, wherein said second nanoparticle reactant comprises a reducing agent.

14. The method of claim 13, wherein said reducing agent comprises one of sodium citrate (Na₃C₆H₅O₇), potassium hydroxide (KOH), or potassium sulfite (K₂SO₃) dissolved in water.

15. A system for forming nanoparticles in-situ comprising:
a substrate transport system;
an inkjet material dispenser disposed adjacent to said substrate transport system; and
an ink reservoir coupled to said inkjet material dispenser;
wherein said ink reservoir includes a plurality of chemically separated chambers;
said chambers being configured to chemically separate a first nanoparticle reactant and a second nanoparticle reactant prior to their being dispensed from said inkjet material dispenser.

16. The system of claim 15, wherein said inkjet material dispenser comprises one of a thermally actuated ink-jet dispenser, a mechanically actuated ink-jet dispenser, an electrostatically actuated ink-jet dispenser, a magnetically actuated dispenser, a piezoelectrically actuated dispenser, or a continuous ink-jet dispenser

17. The system of claim 15, further comprising:
a computing device communicatively coupled to said inkjet material dispenser and to said substrate transport system; and
a processor readable medium communicatively coupled to said computing device, said processor readable medium having instructions thereon, which when accessed by said computing device, cause said system to deposit a first nanoparticle reactant from a printhead onto a desired substrate, and deposit a second nanoparticle reactant from said printhead onto said first reactant, wherein said first nanoparticle reactant is configured to react with said second nanoparticle reactant to form a nanoparticle.

18. The system of claim 17, wherein said processor readable medium further includes instructions thereon, which when accessed by said computing device, forms a desired deposition pattern.

19. The system of claim 18, wherein said desired deposition pattern comprises one of an array, an electrical trace design, or an electrical component design.

20. The system of claim 15, wherein said substrate transport system comprises one of a belt or rollers.

21. The system of claim 15, further comprising a servo mechanism coupled to said inkjet material dispenser, wherein said servo mechanism is configured to positionally translate said inkjet material dispenser.

22. The system of claim 15, wherein said ink reservoir further comprises a reducing agent and a metallic precursor chemically separated in said chemically separated chambers.

23. The system of claim 22, wherein said metallic precursor comprises one of a gold chloride (AuCl₄) or a silver nitrate (AgNO₃) dissolved in water.

24. The system of claim 22, wherein said reducing agent comprises one of sodium citrate (Na₃C₆H₅O₇), potassium hydroxide (KOH), or potassium sulfite (K₂SO₃) dissolved in water.

25. The system of claim 15, further comprising a radiation applicator configured to facilitate a reaction between said first nanoparticle reactant and said second nanoparticle reactant once deposited.

26. The system of claim 25, wherein said radiation applicator is configured to apply one of an ultraviolet (UV) radiation, an infrared (IR) radiation, microwaves, or a laser to said first nanoparticle reactant and said second nanoparticle reactant once deposited.

27. A processor readable medium having instructions thereon, which when accessed by a computing device, cause said computing device to deposit a first nanoparticle reactant from a printhead onto a desired substrate, and deposit a second nanoparticle reactant from said printhead onto said first reactant, wherein said first nanoparticle reactant is configured to react with said second nanoparticle reactant to form a nanoparticle.

28. The processor readable medium of claim 27, wherein said processor readable medium further includes instructions thereon, which when accessed by said computing device, forms a desired deposition pattern.

29. The processor readable medium of claim 28, wherein said desired deposition pattern comprises one of an array, an electrical trace design, or an electrical component design.

30. An inkjet printhead comprising:
a plurality of chemically separated chambers;
wherein said chambers are configured to chemically separate a first nanoparticle reactant and a second nanoparticle reactant prior to deposition on a desired substrate.

31. The inkjet printhead of claim 30, wherein said printhead comprises one of a thermally actuated inkjet dispenser, a mechanically actuated inkjet dispenser, an electrostatically actuated inkjet dispenser, a magnetically actuated dispenser, a piezoelectrically actuated dispenser, or a continuous inkjet dispenser.

32. The inkjet printhead of claim 30, further comprising a servo mechanism coupled to said inkjet printhead, said servo mechanism being configured to controllably translate said inkjet printhead.

33. A means for forming nanoparticles in-situ comprising:
a substrate transport system;
a means for selectively dispensing reactants disposed adjacent to said substrate transport system; and
a means for storing reactants coupled to said means for selectively dispensing reactants;
wherein said means for storing reactants includes a plurality of chemically separated chambers;
said chambers being configured to chemically separate a first nanoparticle reactant and a second nanoparticle reactant prior to their being dispensed from said inkjet material dispenser.

34. The system of claim 33, wherein said means for selectively dispensing reactants comprises one of a thermally actuated ink-jet dispenser, a mechanically actuated ink-jet dispenser, an electrostatically actuated ink-jet dispenser, a magnetically actuated dispenser, a piezoelectrically actuated dispenser, or a continuous ink-jet dispenser

35. The system of claim 33, further comprising:
means for processing data communicatively coupled to said means for selectively dispensing reactants and to said substrate transport system; and
means for storing data communicatively coupled to said means for processing data, said means for storing data having instructions thereon, which when accessed by said means for processing data, cause said system to deposit a first nanoparticle reactant from said means for selectively dispensing reactants onto a desired substrate, and deposit a second nanoparticle reactant from said means for selectively dispensing reactants onto said first reactant, wherein said first nanoparticle reactant is configured to react with said second nanoparticle reactant to form a nanoparticle.

36. The system of claim 35, wherein said means for storing data further includes instructions thereon, which when accessed by said means for processing data, forms a desired deposition pattern.

37. The system of claim 36, wherein said desired deposition pattern comprises one of an array, an electrical trace design, or an electrical component design.

38. The system of claim 33, wherein said means for storing reactants further comprises a reducing agent and a metallic precursor chemically separated in said chemically separated chambers.

39. The system of claim 38, wherein said metallic precursor comprises one of a gold chloride (HAuCl₄) or a silver nitrate (AgNO₃) dissolved in water.

40. The system of claim 38, wherein said reducing agent comprises one of sodium citrate (Na₃C₆H₅O₇), potassium hydroxide (KOH), or potassium sulfite (K₂SO₃) dissolved in water.

41. The system of claim 33, further comprising a radiation applicator configured to facilitate a reaction between said first nanoparticle reactant and said second nanoparticle reactant once deposited.

42. The system of claim 41, wherein said radiation applicator is configured to apply one of an ultraviolet (UV) radiation, an infrared (IR) radiation, microwaves, or a laser to said first nanoparticle reactant and said second nanoparticle reactant once deposited.
